(19) United States
(12) Patent Application Publication
(10) Pub. No.: US 2026/0095349 A1
(43) Pub. Date: Apr. 2, 2026

(54) METHOD AND APPARATUS FOR ESTIMATION OF FREQUENCY DOMAIN CHANNEL CORRELATION FROM NARROWBAND REFERENCE SIGNAL

(71) Applicant: Samsung Electronics Co., Ltd., Gyeonggi-do (KR)

(72) Inventors: Rohan R. POTE, San Diego, CA (US); Federico PENNA, San Diego, CA (US); Hyuk Joon KWON, San Diego, CA (US); Dongwoon BAI, San Diego, CA (US)

(21) Appl. No.: 19/323,673

(22) Filed: Sep. 9, 2025

Related U.S. Application Data
(60) Provisional application No. 63/699,895, filed on Sep. 27, 2024.

(51) Int. Cl. H04L 25/02; H04B 17/364

(52) U.S. Cl. CPC H04L 25/0224; H04B 17/364; H04L 25/0212; H04L 25/022

(57) ABSTRACT

A system and a method are disclosed for NBCE in wireless communication. A method performed by an electronic device includes receiving a narrow band reference signal; estimating frequency domain correlation matrices using the narrow band reference signal; and performing narrow band channel estimation on the narrow band reference signal, using the estimated frequency domain correlation matrices.

### CROSS-REFERENCE TO RELATED APPLICATION

This application claims the priority benefit under 35 U.S.C. § 119 (c) of U.S. Provisional Application No. 63/699,895, filed on Sep. 27, 2024, the disclosure of which is incorporated by reference in its entirety as if fully set forth herein.

### TECHNICAL FIELD

The disclosure generally relates to channel estimation (CE). More particularly, the subject matter disclosed herein relates to improvements to CE in orthogonal frequency division multiplexing (OFDM) systems communication systems.

### SUMMARY

In communication systems such as 5th generation (5G) and beyond, narrowband channel estimation (NBCE) primarily refers to channel estimation techniques designed for narrowband systems or narrowband scenarios within wider bandwidth systems. NBCE may be used in various 5G use cases, e.g., massive machine type communication (mMTC) and/or Internet of things (IoT) applications, where devices operate with limited power and bandwidth resources. NBCE may be used in wireless communication to estimate a channel over a relatively narrow portion of a system bandwidth, e.g., 1, 2, or 4 resource blocks (RBs), generally focusing on determining characteristics of a communication channel where signal bandwidth is significantly smaller than carrier frequency.

In long term evolution (LTE) or new radio (NR) communication, NBCE may be enabled by the presence of pilot symbols, e.g., a demodulation reference signal (DMRS). In general, it is assumed that some type of narrowband reference signal is available for the purpose of channel estimation.

To perform NBCE, frequency domain (FD) channel correlation coefficients, e.g., matrices R_{p,p} and R_{h,p}, may be used. Typically, the correlation coefficients can be estimated from a wideband reference signal (e.g., a tracking reference signal (TRS)) that is quasi-colocated (QCL'ed) with a narrowband reference signal used for NBCE (e.g., a DMRS). These two reference signals (or more specifically, two antenna ports) are said to be QCL'ed when they share (at least a subset of) the same channel properties, including Doppler Shift, Doppler Spread, Average Delay, Delay Spread, etc., such that the channel statistics for one antenna port can be inferred from the other antenna port.

However, the presence of a QCL'ed wideband reference signal is not always guaranteed, e.g., depending on a base station (gNB) configuration. Furthermore, a QCL relationship between a wideband signal (e.g., a TRS) and a narrowband signal (e.g., a DMRS) may only hold approximately, or even be violated, in some practical scenarios. More specifically, a QCL violation (or QCL mismatch) occurs when actual channel conditions between the two signals differ significantly from the QCL assumptions made by a receiver.

Accordingly, if a QCL'ed wideband reference signal is not available, only holds approximately, or a QCL violation occurs, the FD correlation coefficients may not be estimated correctly, making NBCE performance unreliable or even unavailable.

To solve these types of problems, the present disclosure provides various methods for estimating FD channel correlation coefficients based on available narrowband observations without the need for a QCL'ed wideband reference signal. That is, in accordance with an aspect of the present disclosure, the present disclosure provides various methods for estimating FD channel correlation coefficients that do not rely on a QCL'ed wideband reference signal, but on the available narrowband observations.

More specifically, the present disclosure provides various methods for power delay profile (PDP) estimation based on least squares (LS), sparse Bayesian learning (SBL), or block SBL (BSBL). For these methods, the estimated PDP may be converted to FD channel correlation coefficients and then used to perform NBCE. A PDP may refer a measurement in wireless communication that shows average received signal power as a function of propagation time delay. For example, a PDP may be used to visualize how a signal, after being transmitted, arrives at the receiver via multiple paths (multipath propagation), with each path having a different delay and attenuated power.

The above approaches improve on previous methods because they enhance robustness to QCL mismatch as they may utilize available narrowband signals (e.g., DMRSs) without requiring an additional wideband signal (e.g., a TRS) to perform NBCE.

The above approaches are also practical due to the low algorithmic complexity.

The above approaches are also robust to noisy delay spread parameter values.

In an embodiment, a method performed by an electronic device includes receiving a narrow band reference signal; estimating frequency domain correlation matrices using the narrow band reference signal; and performing narrow band channel estimation on the narrow band reference signal, using the estimated frequency domain correlation matrices.

In an embodiment, an electronic device comprises a transceiver; and a processor configured to receive, via the transceiver, a narrow band reference signal, estimate frequency domain correlation matrices using the narrow band reference signal, and perform narrow band channel estimation on the narrow band reference signal, using the estimated frequency domain correlation matrices.

### BRIEF DESCRIPTION OF THE DRAWING

In the following section, the aspects of the subject matter disclosed herein will be described with reference to exemplary embodiments illustrated in the figures, in which:

FIG. 1 illustrates a method of performing NBCE using a wideband reference signal that is QCL'ed with a narrowband reference signal;

FIG. 2 illustrates a method of performing NBCE using a narrowband reference signal, according to an embodiment;

FIG. 3 illustrates a method of performing NBCE using a narrowband reference signal including an adaptive delay spread (DS) procedure, according to an embodiment;

FIG. 4 illustrates a method of performing NBCE using a narrowband reference signal including an adaptive DS procedure, according to an embodiment;

FIG. 5 is a flowchart illustrating a method performed by an electronic device, according to an embodiment;

FIG. 6 is a block diagram of an electronic device in a network environment, according to an embodiment; and

FIG. 7 shows a system including a UE and a gNB in communication with each other, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and case of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

Although embodiments of the disclosure are described below with reference to a downlink of an NR system, the embodiments are also applicable to uplink and/or sidelink transmission as well as other types of communication systems.

As described above, to perform NBCE, FD correlation coefficients can be estimated from a wideband reference signal (e.g., a TRS) that is QCL'ed with a narrowband reference signal (e.g., a DMRS).

However, the presence of a QCL'ed wideband reference signal is not always guaranteed, and a QCL relationship between a wideband signal (e.g., a TRS) and a narrowband signal (e.g., a DMRS) may only hold approximately, or even be violated, when actual channel conditions between the two signals differ significantly from QCL assumptions made by a receiver. If a QCL'ed wideband reference signal is not available, only holds approximately, or a QCL violation occurs, the FD correlation coefficients may not be estimated correctly, making NBCE performance unreliable or unavailable.

The disclosure provides various methods for estimating FD channel correlation coefficients based on available narrowband observations without the need for a QCL'ed wideband reference signal. That is, the present disclosure provides various methods for estimating FD channel correlation coefficients that do not rely on a QCL'ed wideband reference signal, but on available narrowband observations.

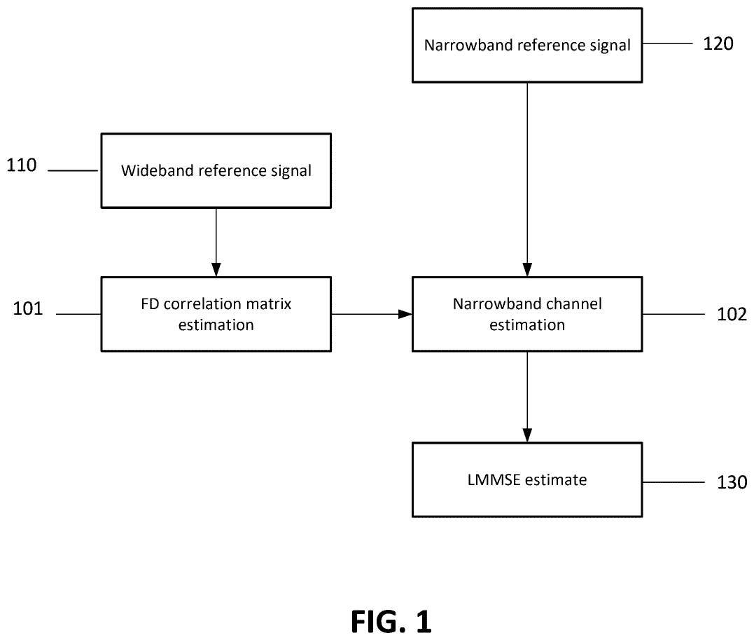

FIG. 1 illustrates a method of performing NBCE using a wideband reference signal that is QCL'ed with a narrowband reference signal.

Referring to FIG. 1, an electronic device may receive a wideband reference signal yₑₓₜₑᵣₙₐₗ (e.g., a TRS) 110 that is QCL'ed with a narrowband reference signal y (e.g., a physical downlink shared channel (PDSCH) DMRS signal) 120. A TRS may be a type of channel state information reference signal (CSI-RS) used for fine-grained time and frequency tracking by a UE to compensate for time and frequency deviations during downlink data transmission.

As described above, to perform NBCE at 102, FD channel correlation coefficients, e.g., matrices R_{p,p} and R_{h,p}, may be used. At 101, the correlation coefficients can be estimated from wideband reference signal yₑₓₜₑᵣₙₐₗ 110 that is QCL'ed with narrowband reference signal y 120. Various methods may be used to estimate correlation coefficients from a wideband reference signal. For example, a wideband reference signal may be transformed to a delay domain (DD) using an inverse discrete Fourier transform (IDFT). A resulting DD signal may be de-noised and a PDP may be estimated from the DD signal. Thereafter, FD channel correlation coefficients can be computed from the estimated PDP.

The received vector y∈C^{N}^{ₚ} (Nₚ denotes the number of DMRS subcarriers within a precoding resource block group (PRG)) per OFDM symbol can be modeled as shown in Equation (1).

$$y = {X}_{0} {p}_{0} + {X}_{1} {p}_{1} + n \qquad ( 1 )$$

In Equation (1), X₀=diag([1, 1, . . . , 1, 1]) and X₁=diag([1, −1, . . . , 1, −1]), indicating use of frequency domain-orthogonal cover code (FD-OCC), and pᵢ∈ [symbol] is a channel vector at the DMRS subcarrier locations for port i=0, 1, and n is complex Gaussian random vector with n˜ [symbol] (0,σ²I_{N}_{_{P}}). Although examples of X₀ and X₁ are provided with a specific structure here, the embodiments of the disclosure are not limited thereto, and can be extended to other values of X₀ and X₁ as well. For example, X₁ may be 0.

Hereinafter, for notational simplicity, X₀ may not be explicitly mentioned as it is set to an identity matrix.

By denoting the number of resource blocks (RB) within a PRG as N_{RB}, for N_{RB}=2 and DMRS type 1, Nₚ=12, and for DMRS type 2, Nₚ=8.

Using the FD channel correlation coefficients obtained at 101, i.e., the matrices R_{p,p} and R_{h,p}, and a combined FD-minimum mean squared error (MMSE) algorithm for NBCE at 102, a linear MMSE (LMMSE) estimate ĥᵢ 130 may be given by Equation (2).

$${\hat{h}}_{i} = {R}_{h , p} {{X}_{i}^{H} ( {R}_{p , p} + {X}_{1} {R}_{p , p} {X}_{1}^{H} + {σ}^{2} {I}_{{N}_{p}} )}^{- 1} y \qquad ( 2 )$$

In Equation (2), H denotes a matrix Hermitian transpose or conjugate transpose.

As shown in Equation (2), the matrices R_{p,p} and R_{h,p} estimated at 101 from the wideband reference signal yₑₓₜₑᵣₙₐₗ 110 may be utilized at 102 to perform the NBCE on the narrowband reference signal y 120.

However, as described above, the presence of a QCL'ed wideband reference signal yₑₓₜₑᵣₙₐₗ 110 is not always guaranteed, e.g., depending on a gNB configuration. Furthermore, a QCL relationship between the wideband signal yₑₓₜₑᵣₙₐₗ 110 and the narrowband reference signal y 120 may only hold approximately, or even be violated, in some practical scenarios.

To avoid these types of issues, according to an embodiment of the disclosure, various methods are provided for estimating the matrices R_{p,p} and R_{h,p} from the narrowband reference signal y 120, without having to use the wideband reference signal yₑₓₜₑᵣₙₐₗ 110.

Power delay profile (PDP) is a tool to characterize time dispersion of a multipath channel. It essentially depicts average received signal strength as a function of time delay for each multipath component.

Channel vectors may be expressed in terms of a PDP length L+1—reduced number of DD taps using discrete Fourier transform (DFT) transformation, as shown in Equation (3).

$$y = {X}_{0} {p}_{0} + {X}_{1} {p}_{1} + n = {X}_{0} {F}_{L + 1} {c}_{0} + {X}_{1} {F}_{L + 1} {c}_{1} + n = {{G}_{2 L + 2} [ \begin{matrix}{c}_{0}^{T} & {c}_{1}^{T}\end{matrix} ]}^{T} + n , ( {G}_{2 L + 2} = [ \begin{matrix}{F}_{L + 1} & {X}_{1} {F}_{L + 1}\end{matrix} ] ) \qquad ( 3 )$$

In Equation (3), L denotes an expected length of the PDP, T denotes a transpose operation, c₀ and c₁ represent the DD channel impulse response (CIR) vector, and F_{L+1} may be determined using Equation (4).

$${F}_{L + 1} = F ( REs , 1 : L + 1 ) \qquad ( 4 )$$

In Equation (4), REs denote the DMRS locations in FD, and F denotes the DFT matrix of relatively large size, e.g., N_{FFT}=2048.

For DMRS type I case, REs=[1:2:N_{RB}×12], and for DMRS type II case, REs=[1:6:N_{RB}×12]∪[2:6:N_{RB}×12].

Here, it is assumed that the PDP length L+1 is known.

For a sufficiently high DD resolution, which depends on N_{FFT}, components of cᵢ, i={1,2}, can be assumed to be uncorrelated. It can further be assumed that [c₀; c₁] is zero mean with covariance as shown in Equation (5).

$$Cov ( [ {c}_{0} ; {c}_{1} ] ) = [ Φ0 ; 0 Φ ] \qquad ( 5 )$$

Equation (5) represents a consequence of the common second-order statistics with no cross-correlation assumed across the two layers. Here, a goal is to estimate the diagonal matrix Φ. Thereafter, the matrices for performing NBCE R_{p,p} and R_{h,p} can be computed.

For example, R_{p,p} can be computed using Equation (6).

$${R}_{p , p} = {F}_{L + 1} Φ {F}_{L + 1}^{H} \qquad ( 6 )$$

R_{h,p} can be computed using the estimated PDP Φ as shown in Equation (7).

$${R}_{h , p} = E ( {hp}^{H} ) = F ( 1 : {N}_{RB} \times 12 , 1 : L + 1 ) Φ {F}_{L + 1}^{H} \qquad ( 7 )$$

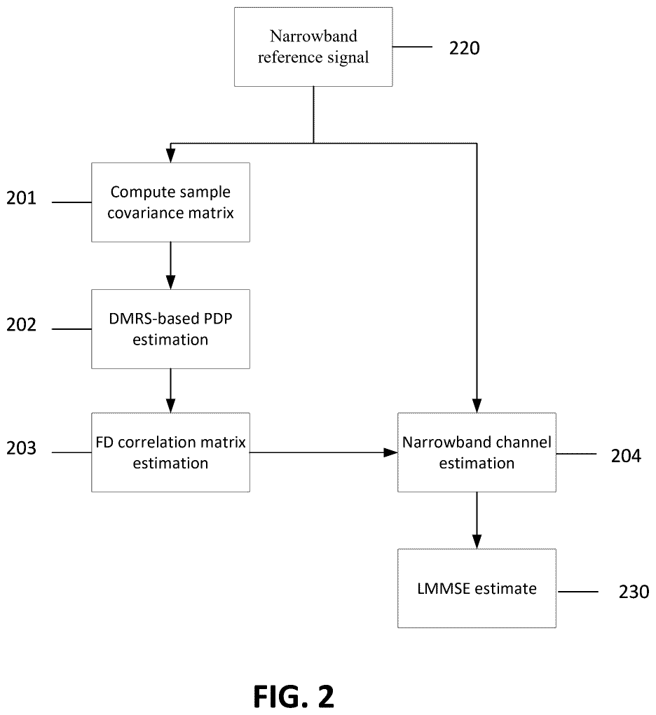

FIG. 2 illustrates a method of performing NBCE using a narrowband reference signal, according to an embodiment. Specifically, FIG. 2 illustrates a method of performing NBCE using a narrowband reference signal y 220, without requiring a wideband reference signal yₑₓₜₑᵣₙₐₗ (e.g., 110 as illustrated in FIG. 1).

Referring to FIG. 2, at 201, an electronic device may compute a sample covariance matrix \hat{R}_{yy} of the received narrowband reference signal y 220, e.g., a DMRS. For example, the sample covariance matrix may be computed as

$$\frac{1}{{N}_{samples}} {\sum }_{i = 1}^{{N}_{samples}} {y}_{i} {y}_{i}^{H} ,$$

where the measurements are collected over frequency, space and time.

At 202, the electronic device may perform DMRS-based PDP estimation using the sample covariance matrix \hat{R}_{yy}, obtaining a diagonal matrix \hat{φ}. According to various embodiments of the disclosure, the DMRS-based PDP estimation at 202 may be performed using an LS method, an SBL-based method, or a BSBL-based method, which will be described below in more detail.

At 203, the electronic device may perform FD correlation matrix estimation using \hat{φ} in order to obtain matrices R_{p,p} and R_{h,p}.

At 204, using matrices R_{p,p} and R_{h,p} estimated from the narrowband reference signal y 220 at 203, the electronic device may perform NBCE on the narrowband reference signal y 220 to obtain an LMMSE estimate ĥᵢ 230, e.g., as given by Equation (2).

As described above, an electronic device may perform DMRS-based PDP estimation (e.g., at 202 in FIG. 2) using a sample covariance matrix \hat{R}_{yy} in order to obtain \hat{φ}, using an LS method.

A covariance matrix \hat{R}_{yy} of the received narrow band signal y 220 may be expressed as shown in Equation (8).

$${R}_{yy} = E ( {yy}^{H} ) = {R}_{p , p} + {X}_{1} {R}_{p , p} {X}_{1}^{H} + {σ}^{2} I = {F}_{L + 1} Φ {F}_{L + 1}^{H} + {X}_{1} {F}_{L + 1} Φ {F}_{L + 1}^{H} {X}_{1}^{H} + {σ}^{2} I \qquad ( 8 )$$

Vectorizing r=R_{yy}−σ²I leads to Equation (9).

$$r = vec ( {R}_{yy} - {σ}^{2} I ) = vec ( {F}_{L + 1} Φ {F}_{L + 1}^{H} ) + vec ( {X}_{1} {F}_{L + 1} Φ {F}_{L + 1}^{H} {X}_{1}^{H} ) = ( {F}_{L + 1}^{c} ⊙ {F}_{L + 1} ) diag ( Φ ) + ( {X}_{1}^{c} {F}_{L + 1}^{c} ⊙ {X}_{1} {F}_{L + 1} ) diag ( Φ ) , = [ ( {F}_{L + 1}^{c} ⊙ {F}_{L + 1} ) + ( {X}_{1}^{c} {F}_{L + 1}^{c} ⊙ {X}_{1} {F}_{L + 1} ) ] ϕ , = [ \begin{matrix}{\sum }_{i = 0}^{1} vec ( {X}_{i} {f}_{0} {f}_{0}^{H} {X}_{i}^{H} ) ) & {\sum }_{i = 0}^{1} vec ( {X}_{i} {f}_{1} {f}_{1}^{H} {X}_{i}^{H} ) ) & ... & {\sum }_{i = 0}^{1} vec ( {X}_{i} {f}_{L} {f}_{L}^{H} {X}_{i}^{H} ) )\end{matrix} ] ϕ \qquad ( 9 )$$

In Equation (9), (⋅)^{c} denotes element-wise conjugate operation, ⊙ denotes the Khatri-Rao product, which is a column-wise Kronecker product, and the notation φ=diag(Φ). For example, consider two matrices D and E with the same number of columns. Then D⊙E=[d₁⊗e₁ d₂⊗e₂ d₃⊗e₃ . . . ], where dⱼ and eⱼ denote the j-th columns of D and E, respectively.

By denoting \hat{r}=vec(\hat{R}_{yy}−σ²I), where \hat{R}_{yy} denotes the sample covariance matrix, the LS solution for PDP estimation (e.g., at 202 of FIG. 2) is given by Equation (10).

$$\hat{ϕ} = {[ ( {F}_{L + 1}^{c} ⊙ {F}_{L + 1} ) + ( {X}_{1}^{c} {F}_{L + 1}^{c} ⊙ {X}_{1} {F}_{L + 1} ) ]}^{+} \cdot \hat{r} \qquad ( 10 )$$

In Equation (10), + denotes Moore-Penrose or pseudo-inverse. Let

$$B = [ ( {F}_{L + 1}^{c} ⊙ {F}_{L + 1} ) + ( {X}_{1}^{c} {F}_{L + 1}^{c} ⊙ {X}_{1} {F}_{L + 1} ) ] .$$

For full column-rank matrices, B, the pseudo-inverse can be computed as (B^{H}B)⁻¹B^{H}. A small regularization, ϵI, may be added to avoid ill-conditioned matrix inverse as shown in Equation (11).

$$\hat{ϕ} = {( {B}^{H} B + ϵ I )}^{- 1} {B}^{H} \cdot \hat{r} \qquad ( 11 )$$

The resulting \hat{φ} may not be a non-negative vector, and as such, an extra step may be performed to set negative components in the estimate to zero.

To reduce the complexity of LS PDP estimation, the number of taps to be estimated can be limited by assuming a “piecewise uniform PDP” as shown in Equation (12).

$$ϕ = {[ {ϕ}_{1}^{′} {1}_{K}^{T} , … , {ϕ}_{{N}_{taps}}^{′} {1}_{K}^{T} ]}^{T} = {ϕ}^{′} ⊗ {1}_{K} \qquad ( 12 )$$

In Equation (12).

$${N}_{taps} = ⌈ \frac{L + 1}{K} ⌉ .$$

With this model, the LS equation may be given by Equation (13).

$$r = vec ( {R}_{yy} - {σ}^{2} I ) = [ B ( : , 1 : K ) {1}_{K} , … , B ( : , ( {N}_{taps} - 1 ) K + 1 : L + 1 ) {1}_{K} ] {ϕ}^{′} = {B}^{′} {ϕ}^{′} \qquad ( 13 )$$

In Equation (13), B′∈ [symbol] . [symbol] may be estimated as shown in Equation (14).

$$\hat{{ϕ}^{′}} = {( ( {B}^{′ H} {B}^{′} ) + ε {I}_{{N}_{taps}} )}^{- 1} {B}^{′ H} \cdot \hat{r} \qquad ( 14 )$$

Using Equation (14), the matrix inverse size is reduced from L+1 to

$${N}_{taps} = ⌈ \frac{L + 1}{K} ⌉ .$$

As described above, an electronic device may perform DMRS-based PDP estimation (e.g., at 202) using a sample covariance matrix \hat{R}_{yy} in order to obtain \hat{φ}, using an SBL-based method.

SBL is a Bayesian technique for recovering a sparse decomposition of signals. More specifically, it is a general framework that may be specialized for the PDP estimation from the received signals in Equation (3) by incorporating a unique FD-OCC structure.

The SBL-based method has some advantages over the LS method in that it exploits sparsity of the PDP and finds φ in a maximum-likelihood estimation sense.

### Imposing Gaussian Prior:

Although a Gaussian prior may be utilized, a sparse signal recovery (SSR) problem need not model an unknown sparse vector obeying a Gaussian prior. Even then, the SBL procedure is to begin imposing an (empirical) Gaussian prior and it learns the prior parameters, i.e., PDP in this case, from the measurements.

The following prior distribution in Equation (15) may be imposed.

$$c ∼ CN ( 0 , Γ := diag ( γ ) ) \qquad ( 15 )$$

In Equation (15), γ=[γ₀, . . . , γ_{2L+1}]^{T}∈ [symbol] ≥0. A post-processing step, after computing Γ, is performed for estimating the desired Φ matrix because of the FD-OCC structure.

### Maximum Likelihood Estimation (MLE) Optimization Problem:

y in Equation (1) is distributed as CN(0, \hat{R}_{yy}), where

$${R}_{yy} = {G}_{2 L + 2} Γ {G}_{2 L + 2}^{H} + {σ}^{2} {I}_{{N}_{p}} .$$

The diagonal entries of Γ are unique as defined under SBL in Equation (15). Thus, a marginalized likelihood maximization problem may be equivalently written as shown in Equation (16).

$$\begin{matrix}{γ}^{*} := arg {max}_{γ \geq 0} {\prod }_{i = 1}^{{N}_{samples}} \frac{1}{det {R}_{yy}} exp ( - {y}_{i}^{H} {R}_{yy}^{- 1} {y}_{i} ) \\ = arg {min}_{γ \geq 0} log det {R}_{yy} + trace ( {R}_{yy}^{- 1} {\hat{R}}_{yy} )\end{matrix} \qquad ( 16 )$$

In Equation (16), it is assumed that multiple independent and identically distributed measurements are available across FD or time domain (TD) and

$${\hat{R}}_{yy} = \frac{1}{{N}_{samples}} {\sum }_{i} {y}_{i} {y}_{i}^{H} .$$

### Iterative Algorithm:

Under the SBL-based method, the optimization in Equation (16) may be solved iteratively. Let

$$L ( γ ) := log det {R}_{yy} + trace ( {R}_{yy}^{- 1} {\hat{R}}_{yy} ) ,$$

and initialize with γ=0 and set one component to a positive value in each iteration. The approach is also greedy in that, that a component of γ is chosen for update, which results in the maximum increase in the loglikelihood function.

Let [symbol] denote the set of column indices of G already added to the model to form

$$R = {G}_{𝕋} {Γ}_{𝕋} {G}_{𝕋}^{H} + {σ}^{2} I .$$

That is, let [symbol] represent the components of γ that are set to positive values. A new column p may be added to the model represented by the set [symbol] .

First, separation is performed for terms in the cost function in Equation (16) that depend on γₖ for some k∈[2L+2]. Using the matrix-inversion lemma, Equation (17) is obtained.

$$L ( {γ}_{𝕋 ⋃ \{ k \}} ) = L ( {γ}_{T} ) + f ( {γ}_{k} , R ) \qquad ( 17 )$$

In Equation (17),

$$f ( {γ}_{k} , R ) = log ( 1 + {γ}_{k} {s}_{k} ) - \frac{{q}_{k} {q}_{k}^{H}}{{γ}_{k}^{- 1} + {s}_{k}} ,$$

$$where$$

$${q}_{k} = \frac{1}{\sqrt{{N}_{samples}}} {g}_{k}^{H} {R}^{- 1} Y$$

$$and$$

$${s}_{k} = {g}_{k}^{H} {R}^{- 1} {g}_{k} ,$$

and where Y=[y₁ y₁ . . . y_{N}_{ₛₐₘₚₗₑₛ}].

A goal here is to select an optimal greedy column index p in this iteration by solving Equation (18).

$$p = arg {min}_{k ∉ T} {min}_{{γ}_{k}} f ( {γ}_{k} , R ) \qquad ( 18 )$$

The minimization of f(γₖ, R) over γₖ can be computed in closed form as shown in Equation (19).

$${\hat{γ}}_{k} = max \{ \frac{{q}_{k} {q}_{k}^{H} - {s}_{k}}{{s}_{k}^{2}} , 0 \} \qquad ( 19 )$$

At the above optimal value of γₖ for each column index k, the problem in Equation (18) reduces as shown in Equation (20).

$$p := arg {max}_{k ∉ T} max \{ \frac{{q}_{k} {q}_{k}^{H}}{{s}_{k}} , 1 \} \qquad ( 20 )$$

The algorithm proceeds by adding p to the model, i.e., updating [symbol] = [symbol] ∪{p} and accordingly updating

$$R = {G}_{𝕋} {Γ}_{𝕋} {G}_{𝕋}^{H} + {σ}^{2} I ,$$

qⱼ and sₖ, which uses the newly computed \hat{γ}ₖ. The latter quantities can be updated in a recursive manner.

The computation of qₖ and sₖ may include computing an inverse of R, which is updated in each iteration. Because only a single column of G_{2L+2} is added per iteration, R⁻¹ can be updated using the matrix inversion lemma. The value at iteration i can be highlighted with superscript (⋅)^{[i]}. More specifically, let (R^{[i]})⁻¹ denote the inverse matrix used in Equation (17) and let p^{[i]} denote the column index to be added at iteration i. Then the inverse matrix is updated for the next iteration, i.e., i+1, as shown in Equation (21).

$${( {R}^{[ i + 1 ]} )}^{- 1} = {( {R}^{[ i ]} + {\hat{γ}}_{{p}^{[ i ]}} {g}_{{p}^{[ i ]}} {g}_{{p}^{[ i ]}}^{H} )}^{- 1} = {( {R}^{[ i ]} )}^{- 1} - \frac{{{w}^{[ i ]} ( {w}^{[ i ]} )}^{H}}{\frac{1}{{\hat{γ}}_{{p}^{[ i ]}}} + {s}_{{p}^{[ i ]}}^{[ i ]}} \qquad ( 21 )$$

In Equation (21), w^{[i]}=(R^{[i]})⁻¹gₚ_{^{[i]}} and

$${s}_{{p}^{[ i ]}}^{[ i ]} = {{g}_{{p}^{[ i ]}}^{H} ( {R}^{[ i ]} )}^{- 1} {g}_{{p}^{[ i ]}} .$$

Thereafter,

$$( {q}_{k}^{[ i ]} , {s}_{k}^{[ i ]} )$$

is updated to get

$$( {q}_{k}^{[ i + 1 ]} , {s}_{k}^{[ i + 1 ]} )$$

as shown in Equations (22) and (23).

$${q}_{k}^{[ i + 1 ]} = {{g}_{k}^{H} ( {R}^{[ i + 1 ]} )}^{- 1} Y = {q}_{k}^{[ i ]} - \frac{{g}_{k}^{H} {w}^{[ i ]}}{\frac{1}{{\hat{γ}}_{{p}^{[ i ]}}} + {s}_{{p}^{[ i ]}}^{[ i ]}} {q}_{{p}^{[ i ]}}^{[ i ]} \qquad ( 22 )$$

$${s}_{k}^{[ i + 1 ]} = {{g}_{k}^{H} ( {R}^{[ i + 1 ]} )}^{- 1} {g}_{k} = {s}_{k}^{[ i ]} - \frac{{\vert {g}_{k}^{H} {w}^{[ i ]} \vert}^{2}}{\frac{1}{{\hat{γ}}_{{p}^{[ i ]}}} + {s}_{{p}^{[ i ]}}^{[ i ]}} \qquad ( 23 )$$

The SBL-method (and the BSBL-based method as will be described below) may depend on measurements Y only through YY^{H}. Thus, the complexity of the algorithm can be reduced by computing \tilde{Y}∈ [symbol] from Y, such that YY^{H}=\tilde{Y}\tilde{Y}^{H}. Such a \tilde{Y} can be computed using a truncated singular value decomposition (SVD).

### Algorithm Steps

Step 1: Initialize \hat{γ}=0, σ², R⁻¹=σ⁻²I, [symbol] =Ø
Step 2: Compute qₖ and sₖ, ∀k∉ [symbol] as in Equation (17) (efficient recursive implementation is provided in Equation (22) and Equation (23)
Step 3: Select best column index as in Equation (20)
Step 4: Compute optimal PDP tap value as in Equation (19) corresponding to the column with index p
Step 5: Add p to the model i.e., update [symbol] = [symbol] ∪{p} and

$$R = {G}_{𝕋} {Γ}_{𝕋} {G}_{𝕋}^{H} + {σ}^{2} I .$$

Go to Step 2, repeat until a predetermined condition is met, e.g., until desired number of PDP taps have been updated OR for 2L+2 iterations.

The SBL-based method does not enforce a required structure while estimating PDP. For the received signal in Equation (1), Equation (24) is true.

$${ϕ}_{k} = {ϕ}_{k + L + 1} \geq 0 , k ∈ [ L + 1 ] \qquad ( 24 )$$

Additionally, the same after the maximum likelihood estimation may be enforced by averaging the two estimates. Thus, the estimate \hat{γ} may be replaced with Equation (25).

$${\hat{ϕ}}_{k} = \frac{1}{2} ( {\hat{γ}}_{k} + {\hat{γ}}_{k + L + 1} ) \qquad ( 25 )$$

The length of the above PDP estimate is L+1, which is a desired length.

As described above, an electronic device may perform DMRS-based PDP estimation using a sample covariance matrix \hat{R}_{yy} in order to obtain \hat{φ}, using a BSBL-based method.

### Imposing Gaussian Prior:

Specifically, the following prior can be imposed using Equation (26).

$$c ∼ CN ( 0 , [ Φ0 ; 0 Φ ] ) \qquad ( 26 )$$

$$In Equation ( 26 ) , Φ = diag ( [ {ϕ}_{0} , ... , {ϕ}_{L} ] ) .$$

### MLE Optimization Problem:

Consequently, y in is distributed as CN(0, R_{yy}), where R_{yy} may be determined in accordance with Equation (27).

$${R}_{yy} = {G}_{2 L + 2} [ Φ0 ; 0 Φ ] {G}_{2 L + 2}^{H} + {σ}^{2} I \qquad ( 27 )$$

The revised marginal likelihood maximization problem may be equivalently written as shown in Equation (28).

$${Φ}^{*} = arg {min}_{{ϕ}_{k} \geq 0 , k ∈ [ L + 1 ]} L ( Φ ) := log det {R}_{yy} + trace ( {R}_{yy}^{- 1} {\hat{R}}_{yy} ) \qquad ( 28 )$$

### Iterative Algorithm:

To impose the prior in Equation (26), two columns with indices {k, k+L+1} for k∈[L+1]\ [symbol] are simultaneously added to the model represented by [symbol] in each iteration as they share the same φₖ. Next, the contribution of φₖ and the associated columns in G_{2L+2} may be written to the cost function in Equation (28), in accordance with Equation (29).

$$L ( {Φ}_{𝕋 ⋃ \{ k , k + L + 1 \}} ) = L ( {ϕ}_{𝕋} ) + h ( {ϕ}_{k} , R ) \qquad ( 29 )$$

In Equation (29),

$$h ( {ϕ}_{k} , R ) := log det ( I + {ϕ}_{k} {S}_{k} ) - trace ( {( {ϕ}_{k}^{- 1} {I}_{2} + {S}_{k} )}^{- 1} {Q}_{k} {Q}_{k}^{H} ) ,$$

where

$${Q}_{k} = {\frac{1}{\sqrt{{N}_{samples}}} [ {g}_{k} {g}_{k + L + 1} ]}^{H} {R}^{- 1} Y$$

and Sₖ=[gₖ g_{k+L+1}]^{H} R⁻¹[gₖ g_{k+L+1}].

A goal is to select an optimal greedy column index pair {p, p+L+1} in this iteration by solving Equation (30).

$$p := arg {min}_{k ∈ [ L + 1 ] \backslash} {min}_{{ϕ}_{k}} h ( {ϕ}_{k} , R ) \qquad ( 30 )$$

Unlike the SBL-based method, the closed-form expression for the inner optimization with respect to φₖ is not known. Accordingly, a heuristic method may be provided, as shown below in Equation (31).

$${\hat{ϕ}}_{k} = max \{ \frac{1}{2} trace ( {S}_{k}^{- 1} ( {Q}_{k} {Q}_{k}^{H} - {S}_{k} ) {S}_{k}^{- 1} ) , 0 \} \qquad ( 31 )$$

Similar steps as for SBL-based method may be followed for updating an inverse matrix R⁻¹ at each iteration, instead of computing the inverse. The matrix inversion lemma may be used as shown in Equation (32).

$$\begin{matrix}{( {R}^{[ i + 1 ]} )}^{- 1} = {( {R}^{[ i ]} + {{\hat{γ}}_{{p}^{[ i ]}} [ {g}_{{p}^{[ i ]}} {g}_{{p}^{[ i ]} + L + 1} ] [ {g}_{{p}^{[ i ]}} {g}_{{p}^{[ i ]} + L + 1} ]}^{H} )}^{- 1} \\ = {( {R}^{[ i ]} )}^{- 1} - {{W}_{b}^{[ i ]} ( {\hat{γ}}_{{p}^{[ i ]}}^{- 1} {I}_{2} + {S}_{{p}^{[ i ]}}^{[ i ]} )}^{- 1} {( {W}_{b}^{[ i ]} )}^{H}\end{matrix} , \qquad ( 32 )$$

In Equation (32),

$${W}_{b}^{[ i ]} = {( {R}^{[ i ]} )}^{- 1} [ {g}_{{p}^{[ i ]}} {g}_{{p}^{[ i ]} + L + 1} ] and {S}_{{p}^{[ i ]}}^{[ i ]} = {[ {g}_{{p}^{[ i ]}} {g}_{{p}^{[ i ]} + L + 1} ]}^{H} {( {R}^{[ i ]} )}^{- 1} [ {g}_{{p}^{[ i ]}} {g}_{{p}^{[ i ]} + L + 1} ] .$$

In contrast to the SBL-based method, since two columns of G_{2L+2} are being added at every iteration, the inverse-update uses a rank-2 modification.

$$( {Q}_{k}^{[ i ]} , {S}_{k}^{[ i ]} )$$

is updated to get

$$( {Q}_{k}^{[ i + 1 ]} , {S}_{k}^{[ i + 1 ]} )$$

as shown in Equations (33) and 34.

$${Q}_{k}^{[ i + 1 ]} = {[ {g}_{k} {g}_{k + L + 1} ]}^{H} {( {R}^{[ i + 1 ]} )}^{- 1} Y = {Q}_{k}^{[ i ]} - {[ {g}_{k} {g}_{k + L + 1} ]}^{H} {{W}_{b}^{[ i ]} ( {\hat{γ}}_{{p}^{[ i ]}}^{- 1} {I}_{2} + {S}_{{p}^{[ i ]}}^{[ i ]} )}^{- 1} {Q}_{{p}^{[ i ]}}^{[ i ]} \qquad ( 33 )$$

$$\begin{matrix}{S}_{k}^{[ i + 1 ]} = {[ {g}_{k} {g}_{k + L + 1} ]}^{H} {( {R}^{[ i + 1 ]} )}^{- 1} [ {g}_{{p}^{[ i ]}} {g}_{{p}^{[ i ]} + L + 1} ] \\ = {S}_{k}^{[ i ]} - {[ {g}_{k} {g}_{k + L + 1} ]}^{H} {{W}_{b}^{[ i ]} ( {\hat{γ}}_{{p}^{[ i ]}}^{- 1} {I}_{2} + {S}_{{p}^{[ i ]}}^{[ i ]} )}^{- 1} {( {W}_{b}^{[ i ]} )}^{H} [ {g}_{{p}^{[ i ]}} {g}_{{p}^{[ i ]} + L + 1} ]\end{matrix} \qquad ( 34 )$$

### Algorithm Steps

Step 1: Initialize \hat{φ}=0, σ², R⁻¹=σ⁻²I, [symbol] =Ø
Step 2: Compute Qₖ and sₖ, ∀k∉ [symbol] as in Equation (29) (efficient recursive implementation is provided in Equations (33) and (34)
Step 3: Select best column index as in Equation (30)
Step 4: Compute optimal PDP tap value as in Equation (31) corresponding to the column with indices p and p+L+1
Step 5: Add [p, p+L+1] to the model i.e., update [symbol] = [symbol] ∪{p, p+L+1} and

$$R = {G}_{𝕋} {Φ}_{𝕋} {G}_{𝕋}^{H} + {σ}^{2} I .$$

Go to Step 2, repeat until a predetermined condition is met, e.g., until desired number of PDP taps have been updated OR for L+1 iterations.

Above-described methods assume that the DS information, in terms of a maximum number of PDP taps, i.e., L+1, is available through other sources. However, in the case when such information is unavailable or partially available, the algorithms may rely on an estimate, which may be modified or adapted over time.

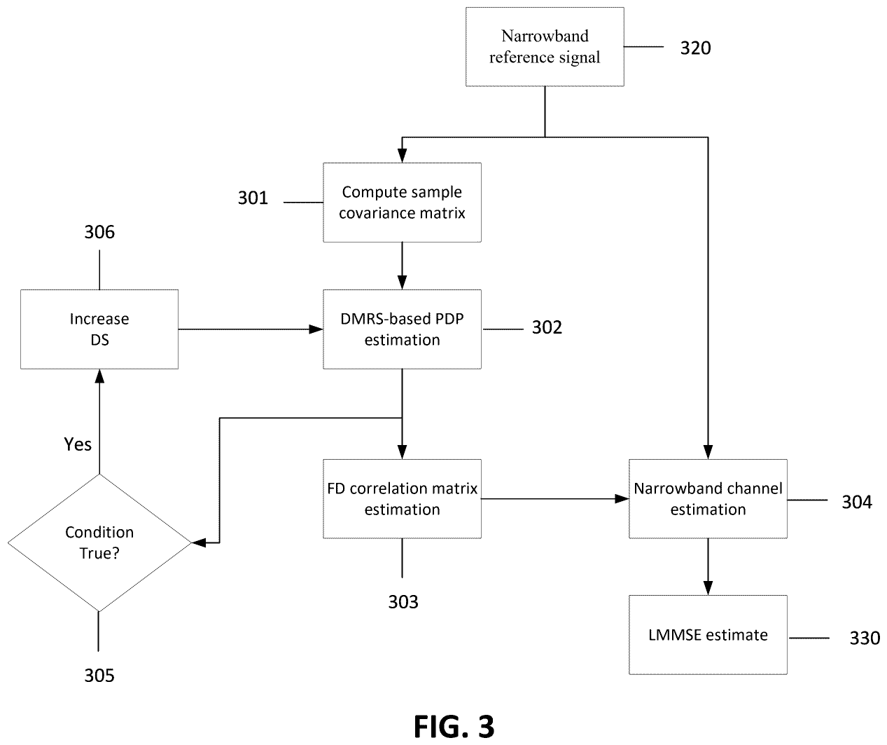

FIG. 3 illustrates a method of performing NBCE using a narrowband reference signal including an adaptive DS procedure, according to an embodiment. More specifically, FIG. 3 illustrates a method of performing NBCE, which includes an adaptive DS procedure in which an initial DS value is set and increased over time.

Referring to FIG. 3, operations at 301 to 304 correspond to those at 201 to 204, respectively, as described above.

At 301, an electronic device may compute a sample covariance matrix \hat{R}_{yy} of the received narrowband reference signal y 320, e.g., a DMRS.

At 302, the electronic device may perform DMRS-based PDP estimation using the sample covariance matrix \hat{R}_{yy}, obtaining a diagonal matrix \hat{φ}.

At 303, the electronic device may perform FD correlation matrix estimation using \hat{φ} in order to obtain matrices R_{p,p} and R_{h,p}.

At 304, using matrices R_{p,p} and R_{h,p} estimated from the narrowband reference signal y 320 at 303, the electronic device may perform NBCE on the narrowband reference signal y 320 to obtain an LMMSE estimate; ĥᵢ 330, e.g., as given by Equation (2).

The electronic device may set an initial DS value, e.g., from a TRS, Lᵢₙᵢₜ, which may be lower than the actual length of the PDP. Here, \hat{φ}∈ [symbol] denotes a PDP estimate obtained using any of the above-described methods. At 305, the electronic devices may determine if the initial DS value should be increased. For example, at 305, the electronic devices may determine if the following condition in Equation (35) holds true.

$$\frac{{\hat{ϕ}}_{L}}{{max}_{k ∈ [ L ]} {\hat{ϕ}}_{k}} > thresh \qquad ( 35 )$$

In Equation (35), the threshold thresh, e.g., {−10,−12,−15} dB, can be chosen using a trial-and-error.

If the condition holds true at 305, then the DS value, i.e., PDP length, may be increased by a fixed amount, e.g., 10 taps, at 306, in order to improve NBCE performance. More specifically, the increased DS value may be utilized in subsequent DMRS-based PDP estimation at 302.

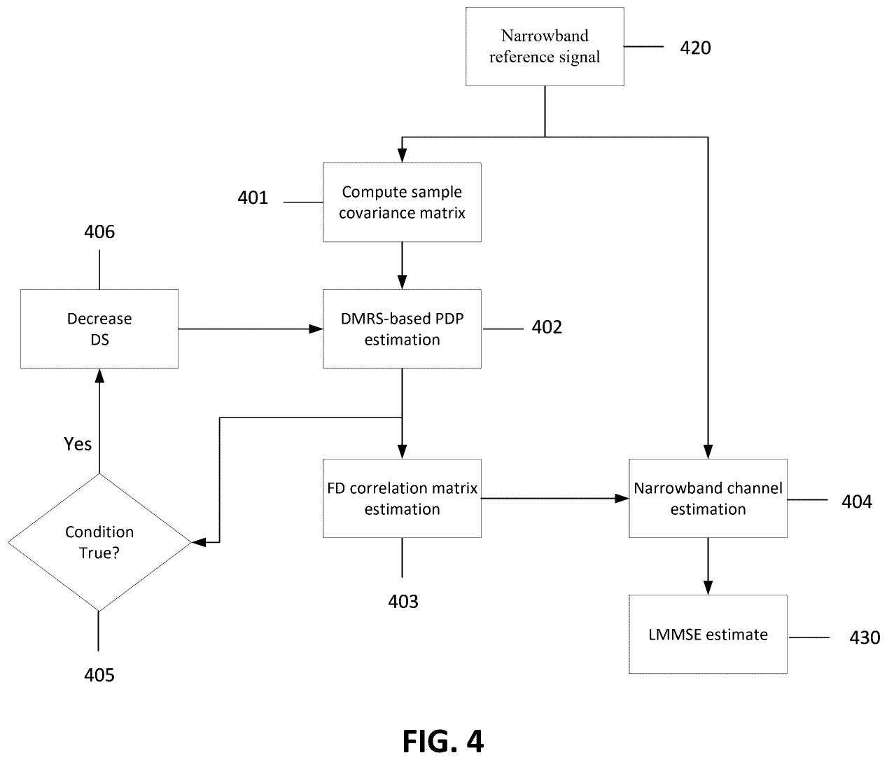

FIG. 4 illustrates a method of performing NBCE using a narrowband reference signal including an adaptive DS procedure, according to an embodiment. More specifically, FIG. 4 illustrates a method of performing NBCE, which includes an adaptive DS procedure in which an initial DS value is set and decreased over time.

Referring to FIG. 4, operations at 401 to 404 correspond to those at 201 to 204, respectively, as described above.

At 401, an electronic device may compute a sample covariance matrix \hat{R}_{yy} of the received narrowband reference signal y 420, e.g., a DMRS.

At 402, the electronic device may perform DMRS-based PDP estimation using the sample covariance matrix \hat{R}_{yy}, obtaining a diagonal matrix \hat{φ}.

At 403, the electronic device may perform FD correlation matrix estimation using \hat{φ} in order to obtain matrices R_{p,p} and R_{h,p}.

At 404, using matrices R_{p,p} and R_{h,p} estimated from the narrowband reference signal y 420 at 403, the electronic device may perform NBCE on the narrowband reference signal y 420 to obtain an LMMSE estimate ĥᵢ 430, e.g., as given by Equation (2).

The electronic device may set an initial DS value, e.g., from a TRS, Lᵢₙᵢₜ, which can be higher than the actual PDP length.

At 405, the electronic devices may determine if the initial DS value should be decreased. For example, at 405, the electronic devices may determine to reduce the DS value, i.e., the PDP length, based on a number of trailing zero taps in an estimated PDP \hat{φ}. In other words, at 405, if the PDP estimate is expressed as shown in Equation (36):

$$\hat{ϕ} = {[ {\hat{ϕ}}_{0} , {\hat{ϕ}}_{1} , ... , {\hat{ϕ}}_{{L}^{′}} , 0 , 0 , ... , 0 ]}^{T} , s . t . {\hat{ϕ}}_{{L}^{′}} > 0 , \qquad ( 36 )$$

then the PDP length may be reduced to some value L′ at 406. More specifically, the decreased DS value may be utilized in subsequent DMRS-based PDP estimation at 402.

Additional reliability may be added to this decision by storing a suggested L′ over multiple slots, and then reducing to a maximum value within the suggestion. For example, the method may wait for two slots during which the estimated PDP has trailing zeros, before reducing the PDP length.

According to another embodiment, a combination of the methods in FIG. 3 and FIG. 4. may also be utilized.

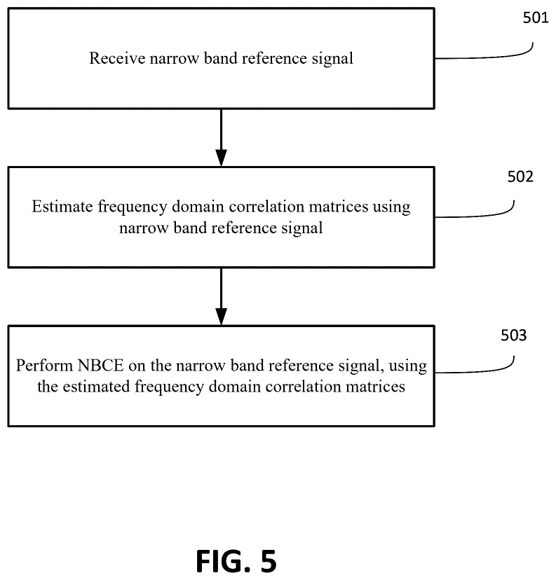

FIG. 5 is a flowchart illustrating a method performed by an electronic device, according to an embodiment.

Referring to FIG. 5, at step 501, the electronic device may receive a narrow band reference signal. For example, as illustrated in at 201 in FIG. 2, the electronic device may compute a sample covariance matrix \hat{R}_{yy} of the received narrowband reference signal y 220, e.g., a DMRS.

At step 502, the electronic device may estimate frequency domain correlation matrices using the narrow band reference signal. For example, as illustrated in FIG. 2, at 202, the electronic device may may perform DMRS-based PDP estimation using the sample covariance matrix \hat{R}_{yy}, obtaining a diagonal matrix \hat{φ}, and at 203, the electronic device may perform FD correlation matrix estimation using \hat{φ} in order to obtain matrices R_{p,p} and R_{h,p}.

At step 503, the electronic device may perform NBCE on the narrow band reference signal, using the estimated frequency domain correlation matrices. For example, as illustrated at 204 in FIG. 2, using matrices R_{p,p} and R_{h,p} estimated from the narrowband reference signal y 220 at 203, the electronic device may perform NBCE on the narrowband reference signal y 220 to obtain an LMMSE estimate ĥᵢ 230. That is, the electronic device may perform NBCE on the narrow band reference signal, without requiring an additional wideband signal (e.g., a TRS).

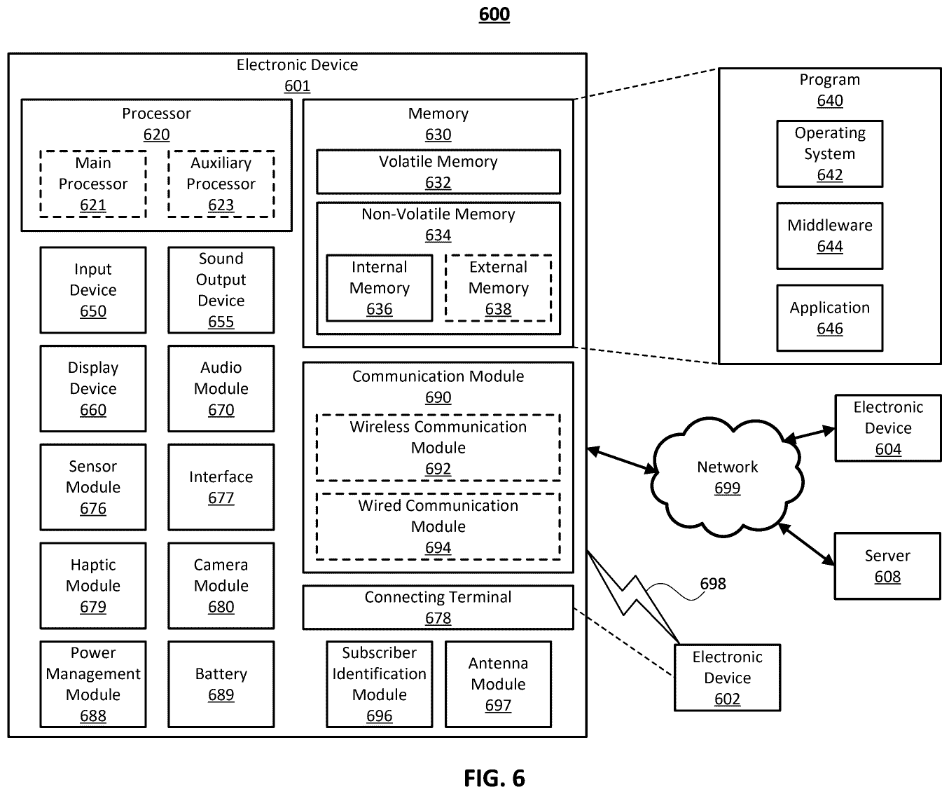

FIG. 6 is a block diagram of an electronic device in a network environment 600, according to an embodiment. For example, an electronic device 601 as illustrated in FIG. 6 may perform NBCE using a narrowband reference signal as illustrated in the method of FIGS. 2, 3, and 4.

Referring to FIG. 6, the electronic device 601 in a network environment 600 may communicate with an electronic device 602 via a first network 698 (e.g., a short-range wireless communication network), or an electronic device 604 or a server 608 via a second network 699 (e.g., a long-range wireless communication network). The electronic device 601 may communicate with the electronic device 604 via the server 608. The electronic device 601 may include a processor 620, a memory 630, an input device 650, a sound output device 655, a display device 660, an audio module 670, a sensor module 676, an interface 677, a haptic module 679, a camera module 680, a power management module 688, a battery 689, a communication module 690, a subscriber identification module (SIM) card 696, or an antenna module 697. In one embodiment, at least one (e.g., the display device 660 or the camera module 680) of the components may be omitted from the electronic device 601, or one or more other components may be added to the electronic device 601. Some of the components may be implemented as a single integrated circuit (IC). For example, the sensor module 676 (e.g., a fingerprint sensor, an iris sensor, or an illuminance sensor) may be embedded in the display device 660 (e.g., a display).

The processor 620 may execute software (e.g., a program 640) to control at least one other component (e.g., a hardware or a software component) of the electronic device 601 coupled with the processor 620 and may perform various data processing or computations, e.g., in accordance with the methods illustrated in FIGS. 2, 3, and 4.

As at least part of the data processing or computations, the processor 620 may load a command or data received from another component (e.g., the sensor module 676 or the communication module 690) in volatile memory 632, process the command or the data stored in the volatile memory 632, and store resulting data in non-volatile memory 634. The processor 620 may include a main processor 621 (e.g., a central processing unit (CPU) or an application processor (AP)), and an auxiliary processor 623 (e.g., a graphics processing unit (GPU), an image signal processor (ISP), a sensor hub processor, or a communication processor (CP)) that is operable independently from, or in conjunction with, the main processor 621. Additionally or alternatively, the auxiliary processor 623 may be adapted to consume less power than the main processor 621, or execute a particular function. The auxiliary processor 623 may be implemented as being separate from, or a part of, the main processor 621.

The auxiliary processor 623 may control at least some of the functions or states related to at least one component (e.g., the display device 660, the sensor module 676, or the communication module 690) among the components of the electronic device 601, instead of the main processor 621 while the main processor 621 is in an inactive (e.g., sleep) state, or together with the main processor 621 while the main processor 621 is in an active state (e.g., executing an application). The auxiliary processor 623 (e.g., an image signal processor or a communication processor) may be implemented as part of another component (e.g., the camera module 680 or the communication module 690) functionally related to the auxiliary processor 623.

The memory 630 may store various data used by at least one component (e.g., the processor 620 or the sensor module 676) of the electronic device 601. The various data may include, for example, software (e.g., the program 640) and input data or output data for a command related thereto. The memory 630 may include the volatile memory 632 or the non-volatile memory 634. Non-volatile memory 634 may include internal memory 636 and/or external memory 638.

The program 640 may be stored in the memory 630 as software, and may include, for example, an operating system (OS) 642, middleware 644, or an application 646.

The input device 650 may receive a command or data to be used by another component (e.g., the processor 620) of the electronic device 601, from the outside (e.g., a user) of the electronic device 601. The input device 650 may include, for example, a microphone, a mouse, or a keyboard.

The sound output device 655 may output sound signals to the outside of the electronic device 601. The sound output device 655 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 660 may visually provide information to the outside (e.g., a user) of the electronic device 601. The display device 660 may include, for example, a display, a hologram device, or a projector and control circuitry to control a corresponding one of the display, hologram device, and projector. The display device 660 may include touch circuitry adapted to detect a touch, or sensor circuitry (e.g., a pressure sensor) adapted to measure the intensity of force incurred by the touch.

The audio module 670 may convert a sound into an electrical signal and vice versa. The audio module 670 may obtain the sound via the input device 650 or output the sound via the sound output device 655 or a headphone of an external electronic device 602 directly (e.g., wired) or wirelessly coupled with the electronic device 601.

The sensor module 676 may detect an operational state (e.g., power or temperature) of the electronic device 601 or an environmental state (e.g., a state of a user) external to the electronic device 601, and then generate an electrical signal or data value corresponding to the detected state. The sensor module 676 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 677 may support one or more specified protocols to be used for the electronic device 601 to be coupled with the external electronic device 602 directly (e.g., wired) or wirelessly. The interface 677 may include, for example, a high-definition multimedia interface (HDMI), a universal serial bus (USB) interface, a secure digital (SD) card interface, or an audio interface.

A connecting terminal 678 may include a connector via which the electronic device 601 may be physically connected with the external electronic device 602. The connecting terminal 678 may include, for example, an HDMI connector, a USB connector, an SD card connector, or an audio connector (e.g., a headphone connector).

The haptic module 679 may convert an electrical signal into a mechanical stimulus (e.g., a vibration or a movement) or an electrical stimulus which may be recognized by a user via tactile sensation or kinesthetic sensation. The haptic module 679 may include, for example, a motor, a piezoelectric element, or an electrical stimulator.

The camera module 680 may capture a still image or moving images. The camera module 680 may include one or more lenses, image sensors, image signal processors, or flashes. The power management module 688 may manage power supplied to the electronic device 601. The power management module 688 may be implemented as at least part of, for example, a power management integrated circuit (PMIC).

The battery 689 may supply power to at least one component of the electronic device 601. The battery 689 may include, for example, a primary cell which is not rechargeable, a secondary cell which is rechargeable, or a fuel cell.

The communication module 690 may support establishing a direct (e.g., wired) communication channel or a wireless communication channel between the electronic device 601 and the external electronic device (e.g., the electronic device 602, the electronic device 604, or the server 608) and performing communication via the established communication channel. The communication module 690 may include one or more communication processors that are operable independently from the processor 620 (e.g., the AP) and supports a direct (e.g., wired) communication or a wireless communication. The communication module 690 may include a wireless communication module 692 (e.g., a cellular communication module, a short-range wireless communication module, or a global navigation satellite system (GNSS) communication module) or a wired communication module 694 (e.g., a local area network (LAN) communication module or a power line communication (PLC) module). A corresponding one of these communication modules may communicate with the external electronic device via the first network 698 (e.g., a short-range communication network, such as BLUETOOTH™, wireless-fidelity (Wi-Fi) direct, or a standard of the Infrared Data Association (IrDA)) or the second network 699 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 692 may identify and authenticate the electronic device 601 in a communication network, such as the first network 698 or the second network 699, using subscriber information (e.g., international mobile subscriber identity (IMSI)) stored in the subscriber identification module 696.

The antenna module 697 may transmit or receive a signal or power to or from the outside (e.g., the external electronic device) of the electronic device 601. The antenna module 697 may include one or more antennas, and, therefrom, at least one antenna appropriate for a communication scheme used in the communication network, such as the first network 698 or the second network 699, may be selected, for example, by the communication module 690 (e.g., the wireless communication module 692). The signal or the power may then be transmitted or received between the communication module 690 and the external electronic device via the selected at least one antenna.

Commands or data may be transmitted or received between the electronic device 601 and the external electronic device 604 via the server 608 coupled with the second network 699. Each of the electronic devices 602 and 604 may be a device of a same type as, or a different type, from the electronic device 601. All or some of operations to be executed at the electronic device 601 may be executed at one or more of the external electronic devices 602, 604, or 608. For example, if the electronic device 601 should perform a function or a service automatically, or in response to a request from a user or another device, the electronic device 601, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 601. The electronic device 601 may provide the outcome, with or without further processing of the outcome, as at least part of a reply to the request. To that end, a cloud computing, distributed computing, or client-server computing technology may be used, for example.

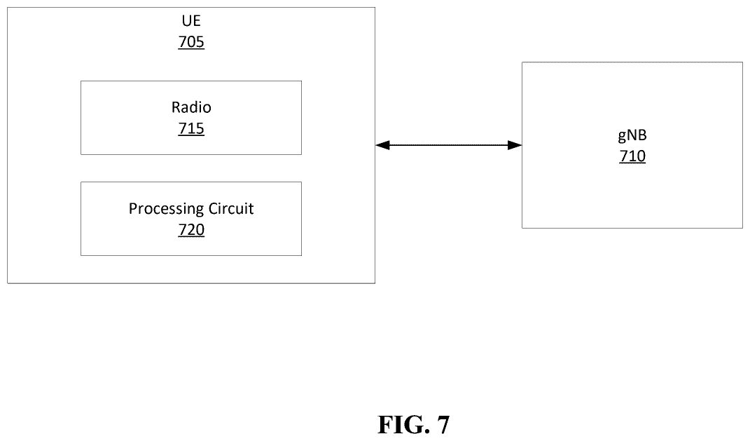

FIG. 7 shows a system including a UE 705 and a gNB 710, in communication with each other, according to an embodiment.

Referring to FIG. 7, the UE may include a radio 715 and a processing circuit (or a means for processing) 720, which may perform various methods disclosed herein, e.g., the methods illustrated in FIGS. 2, 3, and 4. For example, the processing circuit 720 may receive, via the radio 715, transmissions, e.g., a narrowband reference signal, from the network node (gNB) 710, and the processing circuit 720 may transmit, via the radio 715, signals to the gNB 710. The processing circuit 720 may also perform various data processing or computations, e.g., in accordance with the methods illustrated in FIGS. 2, 3, and 4.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method performed by an electronic device, the method comprising:
receiving a narrow band reference signal;
estimating frequency domain correlation matrices using the narrow band reference signal; and
performing narrow band channel estimation on the narrow band reference signal, using the estimated frequency domain correlation matrices.

2. The method of claim 1, wherein estimating frequency domain correlation matrices using the narrow band reference signal comprises:
computing a sample covariance matrix using the narrow band reference signal;
estimating a power delay profile (PDP) of the narrow band reference signal using the sample covariance matrix; and
estimating the frequency domain correlation matrices using the estimated PDP of the narrow band reference signal.

3. The method of claim 2, wherein estimating the PDP of the narrow band reference signal comprises estimating the PDP of the narrow band reference signal using a least squares method.

4. The method of claim 2, wherein estimating the PDP of the narrow band reference signal comprises estimating the PDP of the narrow band reference signal using a sparse Bayesian learning-based method.

5. The method of claim 4, wherein estimating the PDP of the narrow band reference signal using the sparse Bayesian learning-based method comprises:
initializing variables including an estimated PDP, an inverse covariance matrix, and a set of indices;
computing, based on the initialized variables, a first matrix and a second matrix for indices not included in the set of indices;
selecting a column using the computed first and second matrices;
computing a PDP tap value corresponding to the column with a first index;
updating the set of indices with the first index; and
repeating the computing, selecting, computing, and updating until a predetermined condition is met.

6. The method of claim 2, wherein estimating the PDP of the narrow band reference signal comprises estimating the PDP of the narrow band reference signal using a block sparse Bayesian learning-based method.

7. The method of claim 6, wherein estimating the PDP of the narrow band reference signal using the block sparse Bayesian learning-based method comprises:
initializing variables including an estimated PDP, an inverse covariance matrix, and a set of indices;
computing, based on the initialized variables, a first matrix and a second matrix for indices not included in the set of indices;
selecting a column using the computed first and second matrices;
computing a PDP tap value corresponding to the column with first and second indices;
updating the set of indices with the first and second indices; and
repeating the computing, selecting, computing, and updating until a predetermined condition is met.

8. The method of claim 1, further comprising adapting delay spread (DS) over time.

9. The method of claim 8, wherein adapting the DS over time comprises:
setting an initial DS value; and
increasing the initial DS value over time, based on a predetermine condition.

10. The method of claim 9, wherein the predetermined condition comprises:
$$\frac{{\hat{ϕ}}_{L}}{{max}_{k ∈ [ L ]} {\hat{ϕ}}_{k}} > thresh ,$$
wherein \hat{φ} represents an estimated power delay profile (PDP) of the narrow band reference signal, L represents a number of PDP taps, and thresh represents a predetermined threshold.

11. The method of claim 8, wherein adapting the DS over time comprises:
setting an initial DS value; and
decreasing the initial DS value over time, based on a predetermined condition.

12. The method of claim 11, wherein the predetermine condition comprises at least one trailing 0 being present in an estimated power delay profile (PDP) of the narrow band reference signal.

13. An electronic device, comprising:
a transceiver; and
a processor configured to:
receive, via the transceiver, a narrow band reference signal,
estimate frequency domain correlation matrices using the narrow band reference signal, and
perform narrow band channel estimation on the narrow band reference signal, using the estimated frequency domain correlation matrices.

14. The electronic device of claim 13, wherein the processor is further configured to estimate frequency domain correlation matrices using the narrow band reference signal by:
computing a sample covariance matrix using the narrow band reference signal;
estimating a power delay profile (PDP) of the narrow band reference signal using the sample covariance matrix; and
estimating the frequency domain correlation matrices using the estimated PDP of the narrow band reference signal.

15. The electronic device of claim 14, wherein the processor is further configured to estimate the PDP of the narrow band reference signal using a least squares method.

16. The electronic device of claim 14, wherein the processor is further configured to estimate the PDP of the narrow band reference signal using a sparse Bayesian learning-based method.

17. The electronic device of claim 14, wherein the processor is further configured to estimate the PDP of the narrow band reference signal using a block sparse Bayesian learning-based method.

18. The electronic device of claim 13, wherein the processor is further configured to adapt delay spread (DS) over time.

19. The electronic device of claim 16, wherein the processor is further configured to adapt the DS over time by:
setting an initial DS value; and
increasing the initial DS value over time, based on a predetermined condition,
wherein the predetermined condition comprises:
$$\frac{{\hat{ϕ}}_{L}}{{max}_{k ∈ [ L ]} {\hat{ϕ}}_{k}} > thresh , and$$
wherein \hat{φ} represents an estimated power delay profile (PDP) of the narrow band reference signal, L represents a number of PDP taps, and thresh represents a predetermined threshold.

20. The electronic device of claim 16, wherein the processor is further configured to adapt the DS over time by:
setting an initial DS value; and
decreasing the initial DS value over time, based on a predetermined condition,
wherein the predetermine condition comprises at least one trailing 0 being present in an estimated power delay profile (PDP) of the narrow band reference signal.
